(19) United States
(12) Patent Application Publication
(10) Pub. No.: US 2025/0079076 A1
(43) Pub. Date: Mar. 6, 2025

(54) COIL COMPONENT

(71) Applicant: Taiyo Yuden Co., Ltd., Tokyo (JP)

(72) Inventor: Yasunori Tanahashi, TOKYO (JP)

(21) Appl. No.: 18/818,689

(22) Filed: Aug. 29, 2024

(30) Foreign Application Priority Data
Aug. 29, 2023 (JP) 2023-138944

(51) Int. Cl. H01F 27/36

(52) U.S. Cl. CPC H01F 27/363

(57) ABSTRACT

Disclosed herein is a coil component including a magnetic base having magnetism, a conductor disposed at part of the magnetic base, an input-side electrode that is disposed on an outer surface of the magnetic base and is connected to one end of the conductor on an input side, an output-side electrode that is disposed on an outer surface of the magnetic base and is connected to one end of the conductor on an output side, and an electrically-conductive shield that is disposed on an outer surface of the magnetic base and is connected to the output-side electrode, a sum of area of the shield and area of the output-side electrode being larger than area of the input-side electrode.

### BACKGROUND

The present disclosure relates to a coil component.

The coil component has a function of canceling out change in a current as a basic function and therefore is used for use purposes of measures against noise and filters, for example, in related art. Further, in recent years, there have been many opportunities to use a power-system inductor as the coil component in order to smooth an alternate current (AC) current of a direct current to direct current (DC-DC) converter, for example.

Meanwhile, the coil component sometimes involves an influence of an electromagnetic field (noise) on electronic components around the coil component in association with increase in the frequency of a circuit used. Thus, there has been proposed a technique in which an electrically-conductive shield is disposed for a coil component and is connected to the ground to reduce electromagnetic field noise.

For example, Japanese Patent Laid-open No. 2018-56505 (hereinafter, referred to as Patent Document 1) discloses a coil component including a shield layer that is disposed on the upper surface of an insulator main body and has higher magnetic permeability than that of the insulator main body.

### SUMMARY

The coil component of Patent Document 1 may require a ground electrode for connecting a shield to a ground separately from external electrodes of coils. In addition, a ground pattern leading to the ground may be required also for a substrate on which the coil component is mounted. However, the ground electrode precludes dealing with size reduction of the coil component. Conversely, formation itself of the ground electrode for the coil component with a reduced size is difficult.

In view of the above-described circumstances, it is desirable to provide a coil component that achieves effects of a shield without requiring connection to a ground.

According to an embodiment of the present disclosure, there is provided a coil component including a magnetic base having magnetism, a conductor disposed at part of the magnetic base, an input-side electrode that is disposed on an outer surface of the magnetic base and is connected to one end of the conductor on an input side, an output-side electrode that is disposed on an outer surface of the magnetic base and is connected to one end of the conductor on an output side, and an electrically-conductive shield that is disposed on an outer surface of the magnetic base and is connected to the output-side electrode. The sum of the area of the shield and the area of the output-side electrode is larger than the area of the input-side electrode.

Further, in the coil component according to an embodiment of the present disclosure, the magnetic base has a first surface on which the input-side electrode and the output-side electrode are disposed, a second surface oriented toward a side opposite to the first surface, and side surfaces that couple the first surface with the second surface. The shield has a second-surface portion disposed on the second surface and a side-surface portion disposed on the side surface.

Moreover, in the coil component according to an embodiment of the present disclosure, in the shield, the area of the second-surface portion is larger than the total area of the side-surface portion.

In addition, in the coil component according to an embodiment of the present disclosure, in the shield, the second-surface portion covers 90% or higher of the second surface.

Further, in the coil component according to an embodiment of the present disclosure, the shield has an overhang portion located to range to the outside relative to the second surface as viewed toward the second surface.

Moreover, in the coil component according to an embodiment of the present disclosure, in the shield, the thickness of the second-surface portion is equal to or smaller than the thickness of the output-side electrode.

In addition, in the coil component according to an embodiment of the present disclosure, the shield contains a material with resistance higher than that of the output-side electrode.

Further, in the coil component according to an embodiment of the present disclosure, the shield is non-magnetic metal.

Moreover, in the coil component according to an embodiment of the present disclosure, the input-side electrode and the output-side electrode are separate from the side surfaces.

In addition, in the coil component according to an embodiment of the present disclosure, the coil component further includes an indication for identification of the input side and the output side of the conductor.

According to an embodiment of the present disclosure, effects of a shield are achieved without requiring connection to the ground.

### BRIEF DESCRIPTION OF THE DRAWINGS

FIG. 1 is a sectional view illustrating a coil component according to a first embodiment of the present disclosure;

FIG. 2 is a perspective view of the upper surface side of the coil component according to the first embodiment of the present disclosure;

FIG. 3 is a perspective view of the lower surface side of the coil component according to the first embodiment of the present disclosure;

FIG. 4 is a sectional view illustrating a coil component of a comparative example;

FIG. 5 is a perspective view of the upper surface side of the coil component of the comparative example;

FIG. 6 is a perspective view of the lower surface side of the coil component of the comparative example;

FIG. 7 is a graph of a far electromagnetic field with a coil component without a shield;

FIG. 8 is a graph of the far electromagnetic field with the coil component of the first embodiment;

FIG. 9 is a graph of the far electromagnetic field in a case in which connection between the shield and an external electrode does not exist;

FIG. 10 is a diagram schematically illustrating a measurement environment of a near electromagnetic field;

FIG. 11 is a three-dimensional graph illustrating a near magnetic field with the coil component without the shield;

FIG. 12 is a two-dimensional graph illustrating the near magnetic field with the coil component without the shield;

FIG. 13 is a three-dimensional graph illustrating the near magnetic field with the coil component of the first embodiment;

FIG. 14 is a two-dimensional graph illustrating the near magnetic field with the coil component of the first embodiment;

FIG. 15 is a three-dimensional graph illustrating a near electric field with the coil component without the shield;

FIG. 16 is a two-dimensional graph illustrating the near electric field with the coil component without the shield;

FIG. 17 is a three-dimensional graph illustrating the near electric field with the coil component of the first embodiment;

FIG. 18 is a two-dimensional graph illustrating the near electric field with the coil component of the first embodiment;

FIG. 19 is a sectional view illustrating a coil component of a second embodiment;

FIG. 20 is a perspective view of the upper surface side of the coil component of the second embodiment;

FIG. 21 is a perspective view of the lower surface side of the coil component of the second embodiment;

FIG. 22 is a sectional view illustrating a coil component of a third embodiment;

FIG. 23 is a perspective view of the upper surface side of the coil component of the third embodiment;

FIG. 24 is a perspective view of the lower surface side of the coil component of the third embodiment;

FIG. 25 is a sectional view illustrating a coil component of a fourth embodiment;

FIG. 26 is a perspective view of the output side of the coil component of the fourth embodiment;

FIG. 27 is a perspective view of the input side of the coil component of the fourth embodiment; and

FIG. 28 is a sectional view illustrating a coil component of a fifth embodiment.

### DETAILED DESCRIPTION OF THE PREFERRED EMBODIMENTS

Embodiments of the present disclosure will be described in detail below with reference to the accompanying drawings. Note that the following embodiments do not limit the present disclosure and that all of combinations of characteristics described in the embodiments are not necessarily essential for a configuration of the present disclosure. Configurations of the embodiments can be modified or changed as appropriate depending on the specifications and various conditions (use condition, use environment, and other conditions) of an apparatus to which the present disclosure is applied.

The technical scope of the present disclosure is defined by the scope of claims and is not limited by the following individual embodiments. In the drawings used for the following description, the scale and a shape, for example, are made different from an actual structure in some cases for facilitation of understanding of the configurations. Regarding a constituent element illustrated in a drawing described earlier, reference thereto is made as appropriate in description of a subsequent drawing in some cases.

### First Embodiment

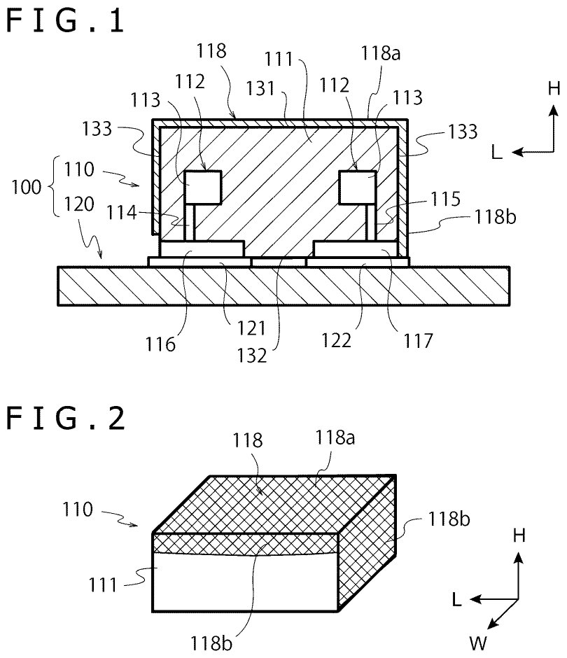

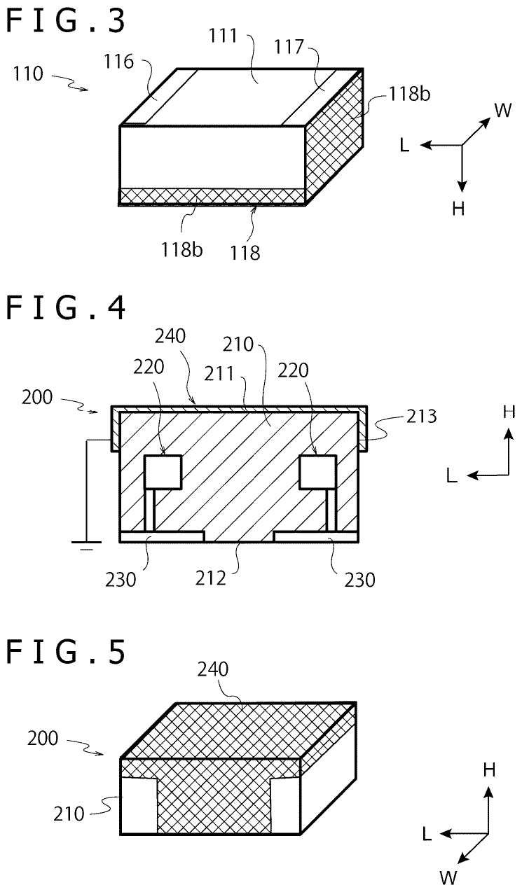

FIGS. 1 to 3 are diagrams illustrating a coil component according to a first embodiment of the present disclosure. A sectional view is illustrated in FIG. 1. A perspective view of the upper surface side is illustrated in FIG. 2. A perspective view of the lower surface side is illustrated in FIG. 3.

A coil component 110 is mounted on a substrate 120. A circuit board 100 includes the coil component 110 and the substrate 120 on which the coil component 110 is mounted. The circuit board 100 is included in various pieces of electronic equipment. As the pieces of electronic equipment including the circuit board 100, electrical components of automobiles, servers, board computers, and various pieces of electronic equipment other than them are envisaged.

In the present specification, for explanation of directions, an “L-axis” direction, a “W-axis” direction, and an “H-axis” direction illustrated in FIGS. 1 to 3 are used as the basis except for a case in which the directions are differently interpreted in terms of the context, and are referred to as a “length” direction, a “width” direction, and a “height” direction, respectively. Note that, in some cases, a plane defined by the L-axis and the W-axis is referred to as an LW-plane, a plane defined by the L-axis and the H-axis is referred to as an LH-plane, and a plane defined by the W-axis and the H-axis is referred to as a WH-plane.

The coil component 110 has a rectangular parallelepiped outer shape as one example. That is, the coil component 110 has an outer surface at each of both ends in the length direction L, both ends in the height direction L, and both ends in the width direction W.

The dimensions of the respective sides in the coil component 110 with the rectangular parallelepiped shape fall within a range of, for example, 1.0 to 4.5 mm in the length direction L, fall within a range of, for example, 0.5 to 3.2 mm in the width direction W, and fall within a range of, for example, 0.5 to 1.0 mm in the height direction H. Further, the dimension in the height direction H is smaller than the dimension in the length direction L. Moreover, the dimension in the height direction H is smaller than the dimension in the width direction W.

The outer surfaces of the coil component 110 may all be either a flat surface or a curved surface. Further, the eight corner parts and the 12 ridge line parts of the coil component 110 may be rounded.

In the present specification, also when part of the outer surfaces of the coil component 110 curves or also when the corner part or the ridge line part of the coil component 110 is rounded, such a shape is referred to as a “rectangular parallelepiped shape” in some cases. That is, the term “rectangular parallelepiped” or “rectangular parallelepiped shape” in the present specification does not mean “rectangular parallelepiped” in a mathematically strict sense.

For example, two land portions 121 and 122 are disposed on the substrate 120. The coil component 110 has a magnetic base 111, an internal conductor 112, external electrodes 116 and 117, and a shield 118. The coil component 110 is mounted on the substrate 120 through joining of the respective external electrodes 116 and 117 to the respective land portions 121 and 122 by solder, for example.

As viewed in the H direction, the area of the respective land portions 121 and 122 is equal to or smaller than 1.6 times the area of the respective external electrodes 116 and 117. More preferably, as viewed in the H direction, the area of the respective land portions 121 and 122 is equal to or smaller than 1.3 times the area of the respective external electrodes 116 and 117.

In the present embodiment, the land portion 121 on the input side and the land portion 122 on the output side are disposed. For example, a signal is input from the land portion 121 on the input side to the coil component 110 and is output from the coil component 110 to the land portion 122 on the output side. Moreover, in the present embodiment, the external electrode 116 on the input side and the external electrode 117 on the output side are disposed. The external electrode 116 on the input side is joined to the land portion 121 on the input side. The external electrode 117 on the output side is joined to the land portion 122 on the output side.

For example, the coil component 110 may be an inductor, may be used as a filter, or may be a common mode choke coil, a transformer, or a composite component. Further, the coil component 110 may be used for a circuit of a DC-DC converter, for example. Owing to use of the coil component 110 including the shield 118, current characteristics with less noise are obtained.

### Structure of Coil Component

The magnetic base 111 is composed of a magnetic material. As the magnetic material for the magnetic base 111, for example, ferrite or a soft magnetic alloy material is used. An example of the ferrite includes Ni-Zn-based ferrite, Mn-Zn-based ferrite, or what contains Cu in them. The magnetic material for the magnetic base 111 may be various crystalline or amorphous alloy magnetic materials and may be a material obtained by combining a crystalline material and an amorphous material.

The crystalline alloy magnetic material that can be used as the magnetic material for the magnetic base 111 is, for example, a crystalline alloy material that is composed mainly of Fe and contains one or more elements among Si, Al, Cr, Ni, Ti, and Zr. The amorphous alloy magnetic material that can be used as the magnetic material for the magnetic base 111 is, for example, an amorphous alloy material that contains at least one of B or C in addition to any of Si, Al, Cr, Ni, Ti, and Zr.

As the magnetic material for the magnetic base 111, pure iron composed of Fe and inevitable impurities may be used. As the magnetic material for the magnetic base 111, a material obtained by combining pure iron composed of Fe and inevitable impurities and various crystalline or amorphous alloy magnetic materials may be used.

The magnetic base 111 may contain a plurality of metal magnetic particles and a resin part disposed in gaps among the plurality of metal magnetic particles. As the metal magnetic particles, FeSiCr, FeSiAl, FeSiCrB, Fe-Ni, and Fe, for example, that are composed mainly of Fe or Ni can be used. Alternatively, a combination of them may be used as the metal magnetic particles, and the metal magnetic particles may contain Si or Bi, for example.

The magnetic base 111 may be fabricated from a composite magnetic material containing a plurality of metal magnetic particles and a binder resin. The binder resin binds the plurality of metal magnetic particles with each other. The binder resin is a thermally-curable resin excellent in the insulation, for example. The magnetic base 111 may be a green compact in which the metal magnetic particles are coupled to each other without the interposition of the binder resin. The material of the magnetic base 111 is not limited to what are clearly specified in the present specification, and any publicly-known materials can be used as the material of the magnetic base.

The magnetic base 111 has a rectangular parallelepiped outer shape as one example. Specifically, the magnetic base 111 has an upper surface 131 at one end in the height direction H and has a lower surface 132 at the other end in the height direction H. Further, the magnetic base 111 has a side surface 133 at each of both ends in the length direction L and both ends in the width direction W.

The internal conductor 112 is composed of a metal material excellent in the electrical conductivity. As the metal material for the internal conductor 112, for example, one or more kinds of metal among Cu, Al, Ni, and Ag or an alloy containing any of these kinds of metal can be used. The internal conductor 112 may be what is obtained by winding a metal conducting wire with a surface on which an insulator coat is disposed, or may be what is formed on a surface of a substrate or sheet, for example, by plating or printing, for example.

The internal conductor 112 of the present embodiment has a circling portion 113 with one or more turns. The number of circles of the circling portion 113 is at least 1.5 turns and at most 10.5 turns, for example. The shape of the circling portion 113 may be either a planar shape or a spiral shape. In the circling portion 113, for example, two circles on the upper side and the lower side may face each other and form one aggregate. A process with any of a winding, a thin film, and layer stacking is used for fabrication of the internal conductor 112, and the fabrication is not particularly limited to any process.

In FIG. 1, the circling portion 113 of what is generally called horizontal winding in which a wire is wound along the LW-plane is exemplified. The internal conductor 112 may have a circling portion of what is generally called vertical winding in which a wire is wound in the direction perpendicular to the LW-plane.

The internal conductor 112 has lead-out portions 114 and 115 for establishing electrical conductivity with the external, on the side of the lower surface 132 of the magnetic base 111. That is, the lead-out portions 114 and 115 connect the external electrodes 116 and 117 to the internal conductor 112. The lead-out portion 114 on the input side leads to, for example, one end on the inner circumferential side, of both ends of the circling portion 113. The lead-out portion 115 on the output side leads to, for example, one end on the outer circumferential side in the circling portion 113. Moreover, the lead-out portion 114 on the input side is connected to the external electrode 116 on the input side. The lead-out portion 115 on the output side is connected to the external electrode 117 on the output side.

The coil component 110 includes the two external electrodes 116 and 117 on, for example, the lower surface 132 of the magnetic base 111. The respective external electrodes 116 and 117 have a metal layer composed of one or more kinds of metal among Ag, Cu, Ti, Ni, and Sn. The metal layer is a layer with a thickness of 1 to 5 μm, for example. The respective external electrodes 116 and 117 may be obtained by combining a plurality of metal layers, and the total thickness is 5 to 10 μm, for example. Further, metal layers partly containing resin may be combined for the respective external electrodes 116 and 117, and the total thickness is 10 to 20 μm, for example. A layer of Ni or Sn may be stacked on the surfaces of the respective external electrodes 116 and 117 by plating, for example.

The external electrodes 116 and 117 are composed of a metal material excellent in the electrical conductivity, as with the internal conductor 112. The external electrodes 116 and 117 are formed of one of or both a layer of the same component as that of the internal conductor 112 and a layer of a component with resistance higher than that of the internal conductor 112. Moreover, the external electrodes 116 and 117 are formed of one of or both a layer with the same filling factor as that of the internal conductor 112 and a layer with a filling factor lower than that of the internal conductor 112.

In the present embodiment, the external electrodes 116 and 117 are disposed on the lower surface 132 of the magnetic base 111. As illustrated in FIG. 1 and so forth, the external electrodes 116 and 117 may be disposed in such a manner that the surfaces thereof are flush with the outer surface (for example, lower surface 132) of the magnetic base 111. Alternatively, the external electrodes 116 and 117 may be disposed in such a manner that the surfaces thereof protrude from the outer surface of the magnetic base 111.

Note that “disposed on a surface” means that an object is disposed at a place visible when the surface is viewed, irrespective of whether the surface of the disposed object protrudes or hollows from the disposing surface. That is, the object may be disposed in such a manner that the surface thereof protrudes to the outside relative to the disposing surface. Alternatively, the object may be disposed in such a manner that the surface thereof hollows inward from the disposing surface. Moreover, a case in which a thin layer interposes between a disposing surface and a disposed object will also be referred to as “disposed on a surface.”

### Structure of Shield

The shield 118 has electrical conductivity and is disposed on one or more outer surfaces among the outer surfaces that the magnetic base 111 has. The shield 118 can alleviate the influence of noise as described later, by being connected to the external electrode 117 on the output side. The shield 118 is not connected to the external electrode 116 on the input side, and another shield connected to the external electrode 116 on the input side also does not exist.

As one example, the shield 118 is disposed on the upper surface 131 of the magnetic base 111 and, for example, covers a range of 10% or higher of the area of the upper surface 131. In the case of the first embodiment, the shield 118 has an upper surface portion 118a that covers the whole of the upper surface 131 and a side-surface portion 118b that covers part of the side surface 133. Owing to the presence of the upper surface portion 118a covering the whole of the upper surface 131, high capability of noise reduction is obtained. It is desirable for the upper surface portion 118a to cover a range of 90% or higher of the area of the upper surface 131.

The shield 118 is disposed with the interposition of an unillustrated insulator between the shield 118 and the outer surface of the magnetic base 111. The thickness of the insulator is smaller than that of the shield. Further, the insulator is unnecessary when the resistance in the outer surface of the magnetic base 111 is sufficiently high.

The sum of the area of the shield 118 and the area of the external electrode 117 on the output side is larger than the area of the external electrode 116 on the input side. Moreover, it is desirable for the area of the shield 118 to be larger than the areas of the respective external electrodes 116 and 117, in terms of noise reduction. Further, it is desirable for the area of the shield 118 to be larger than the sum of the areas of the external electrodes 116 and 117.

Examples of the material of the shield 118 include metal such as Cu, Al, Ni, and Fe or alloys. The material may be a resin material containing metal. As one example, the shield 118 has high resistance compared with the external electrodes 116 and 117. When the external electrodes 116 and 117 have a part (layer) with different resistance, the shield 118 has high resistance compared with the part with low resistance in the external electrodes 116 and 117. For example, when the material of the external electrodes 116 and 117 is Cu or Ag, Al or Fe is used as the material of the shield 118. Moreover, the shield 118 has high resistance compared also with the internal conductor 112.

Noise is reduced owing to the presence of the shield 118, whereas an eddy current may be generated when magnetic flux leaks from the magnetic base 111 to the outside and passes through the shield 118. Thus, reduction in the eddy current may be required. For example, reduction in the eddy current is allowed by causing the shield 118 to have high resistance compared with the external electrodes 116 and 117 and the internal conductor 112 as described above.

Further, as one example, the shield 118 has low resistance compared with the external electrodes 116 and 117. When the external electrodes 116 and 117 have a part (layer) with different resistance, the shield 118 has the same or low resistance compared with the part with low resistance in the external electrodes 116 and 117. For example, Cu and Ag are materials with low resistance, and the same component is contained in each of the external electrodes 116 and 117 and the shield 118.

The shield 118 may have magnetism or be non-magnetic. It is desirable for the shield 118 to be non-magnetic, in terms of reduction in the eddy current. The thickness of the shield 118 is larger than 1 μm but smaller than 1 mm, for example. The thickness of the shield 118 is equal to or smaller than that of the output-side electrode, for example. Moreover, the thickness of the shield 118 is equal to or smaller than half that of the output-side electrode, for example. Further, reduction in the eddy current is allowed by setting the thickness of the shield 118 smaller than that of the external electrodes 116 and 117. For further reduction in the eddy current, it is desirable that the shield 118 be formed to have a small area and a thin thickness regarding the part other than the upper surface portion 118a (for example, side-surface portion 118b).

The external electrodes 116 and 117 are also the same regarding the necessity to intend reduction in the eddy current, and it is preferable that the areas of the external electrodes 116 and 117 be small. Thus, it is desirable that the areas of the external electrodes 116 and 117 necessary for mounting of the coil component 110 be ensured in the lower surface 132 and that the areas of the external electrodes 116 and 117 be small in the surfaces other than the lower surface 132. For example, in the first embodiment, the external electrodes 116 and 117 are disposed only on the lower surface 132 and do not reach the side surfaces 133 and the upper surface 131.

As the forming method of the shield 118, processing from a metal plate or printing, transfer, or atomization, for example, of a metal material can be employed. In the forming method of the shield 118 based on processing, a metal plate is cut to be incorporated into the magnetic base 111 or is fixed to the magnetic base 111 by bonding. In the forming method of the shield 118 based on printing, transfer, or atomization, for example, a mixed material obtained by mixing a metal material into resin, for example, is fabricated and is given to the outer surface of the magnetic base 111 or a surface of an insulator by each method. Moreover, a layer of another metal material may be disposed on the surface of the shield 118 by plating, for example.

### Comparative Example

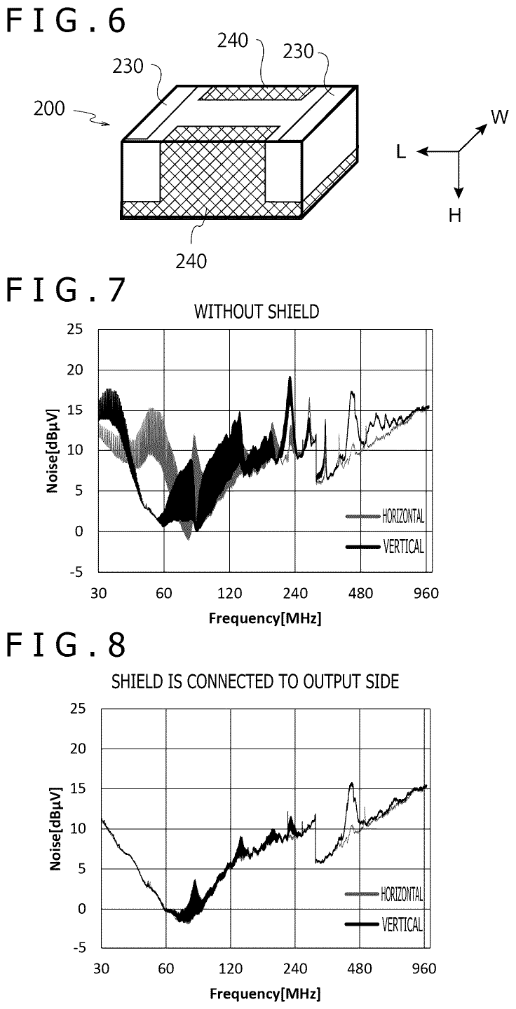

FIGS. 4 to 6 are diagrams illustrating a coil component of a comparative example. A sectional view is illustrated in FIG. 4. A perspective view of the upper surface side is illustrated in FIG. 5. A perspective view of the lower surface side is illustrated in FIG. 6.

As with the coil component 110 of the first embodiment, a coil component 200 of the comparative example includes a magnetic base 210, an internal conductor 220, external electrodes 230, and a shield 240.

Also in the comparative example, the external electrodes 230 are disposed on a lower surface 212 of the magnetic base 210 and are connected to the internal conductor 220. Further, the shield 240 is disposed on an upper surface 211 and side surfaces 213 of the magnetic base 210. Moreover, the shield 240 ranges also over part of the lower surface 212. In the comparative example, the shield 240 does not lead to the external electrode 230 and is connected to the ground through a ground pattern disposed on a substrate separately from land portions on which the external electrodes 230 are mounted. Illustration of a connection line, for example, for connecting the shield 240 to the ground pattern is omitted. In practice, a space for disposing this connection line, for example, may be necessary. Thus, for the coil component 200 of the comparative example, size reduction is difficult, and the mounting area is also large compared with the coil component 110 of the first embodiment.

### Effect of Noise Suppression

An effect of noise suppression by the shield will be described below with reference to measurement results of a far electromagnetic field and a near electromagnetic field.

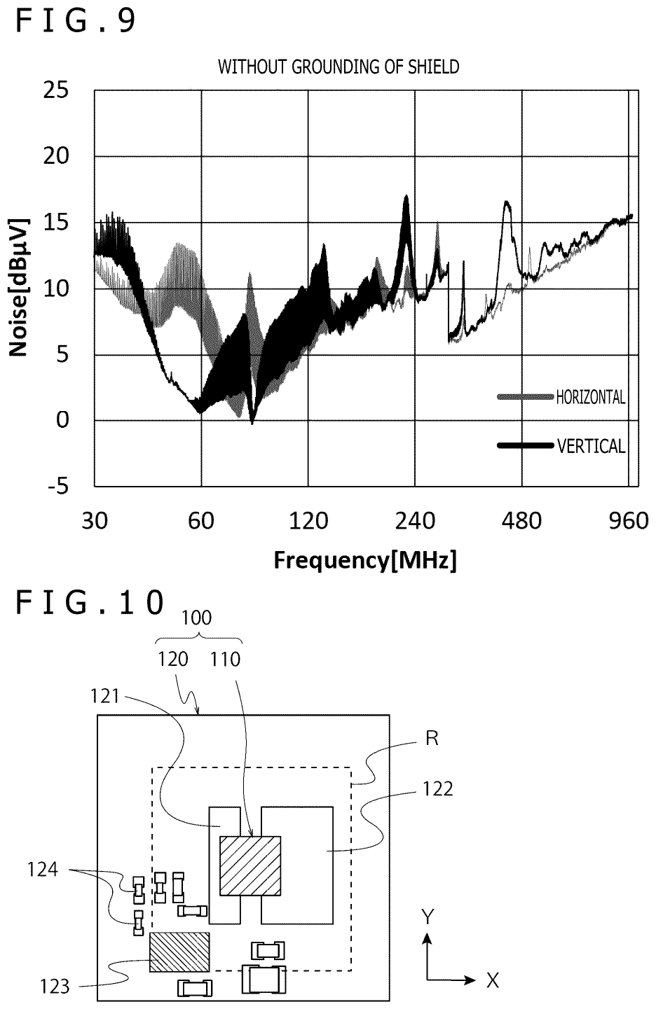

FIG. 7 is a graph of the far electromagnetic field with a coil component in which the shield is not disposed. FIG. 8 is a graph of the far electromagnetic field with the coil component of the first embodiment. FIG. 9 is a graph of the far electromagnetic field in a case in which connection between the shield and the external electrode does not exist in the coil component of the first embodiment.

In the graphs of FIGS. 7 to 9, the abscissa axis indicates the frequency, and the ordinate axis indicates the intensity of the electromagnetic field. The measurement of the electromagnetic field was executed with the coil component disposed in such a manner that an LW-plane was a horizontal plane. Measurement by an antenna in the vertical direction and measurement by an antenna in the horizontal direction were executed. In the graphs of FIGS. 7 to 9, the measurement result of the vertical direction is indicated by a darker line, and the measurement result of the horizontal direction is indicated by a lighter line.

As illustrated in FIG. 7, in the coil component in which the shield is not disposed, large noise is generated in both the vertical direction and the horizontal direction. In contrast, it turns out that noise is suppressed in the case of the coil component 110 of the first embodiment as illustrated in FIG. 8. Further, it has also been confirmed that the effect of noise suppression illustrated in FIG. 8 is equivalent to the effect of noise suppression in the coil component 200 of the comparative example illustrated in FIGS. 4 to 6. Note that the effect of noise suppression is not obtained as illustrated in FIG. 9 in a case in which the shield 118 and the external electrode 117 on the output side are disconnected from each other in the coil component 110 of the first embodiment.

Current change is canceled out on the output side of the coil component 110 of the first embodiment. Therefore, it is thought that an electromagnetic field of noise is suppressed by the shield 118. That is, in the coil component 110 of the first embodiment, the connection of the shield 118 to the ground is unnecessary. In addition, the noise suppression effect by the shield 118 is also sufficiently obtained. Therefore, the electrode and the pattern on the substrate, for example, that may be necessary for the connection of the shield 118 to the ground become unnecessary. This contributes to size reduction and reduction in the mounting area regarding the coil component 110. That is, as lands, only those for input and for output may be necessary.

For example, as viewed from the upper surface 131, the difference between the area of the outer shape of the largest part of the coil component 110 including the shield 118 and the external electrodes 116 and 117 and the area of the outer shape of the magnetic base 111 is equal to or smaller than 5% of the area of the outer shape of the largest part of the coil component 110. Moreover, in mounting of the coil component 110 on the substrate 120, a mounting system in which the area of adhesion to the substrate is smaller than the area of the coil component 110 can also be employed. That is, because connection to the ground is unnecessary, the range of adhesion to the substrate regarding the coil component 110 can be made to fall within the outer shape dimensions of the coil component 110.

Specifically, the coil component 110 can be implemented with a volume smaller than 4 mm³, for example. Further, the coil component 110 can be implemented with an area smaller than, for example, 4 mm² as the area necessary for adhesion to the substrate. In such a manner, the size of the coil component 110 is reduced, and the area of mounting on the substrate 120 is reduced. In addition, the distances to other components can also be shortened owing to noise suppression. This makes it possible to effectively mount a large number of components on the substrate 120.

FIG. 10 is a diagram schematically illustrating the measurement environment of the near electromagnetic field.

The near electromagnetic field is measured at the respective coordinate points of XY-coordinates settled by defining the right direction of FIG. 10 as an X-direction and defining the upward direction as a Y-direction regarding a measurement region R including the coil component 110 mounted on the substrate 120. The X-direction is equivalent to a −L-direction, and the Y-direction is equivalent to a −W-direction. Therefore, the land portion 121 on the input side is located in a −X-direction with respect to the coil component 110, and the land portion 122 on the output side is located in a +X-direction with respect to the coil component 110.

The circuit board 100 is equipped with a switch semiconductor 123 as an element that inputs a signal to the coil component 110, and is also equipped with other elements 124.

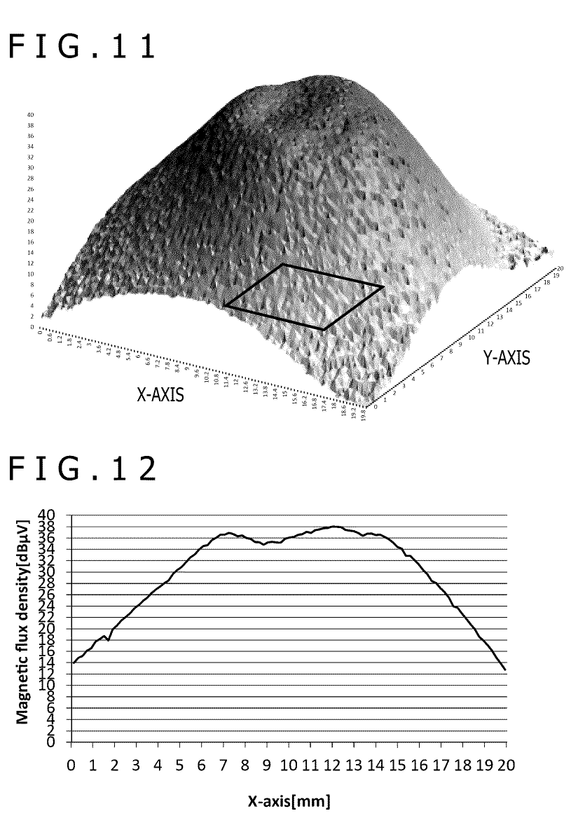

FIGS. 11 and 12 are graphs illustrating the measurement result of a near magnetic field with a coil component that does not include the shield. FIG. 11 illustrates a three-dimensional graph of the measurement result in the measurement region R. FIG. 12 illustrates a graph of the measurement result at each point on a line that traverses the center of the coil component in the X-direction.

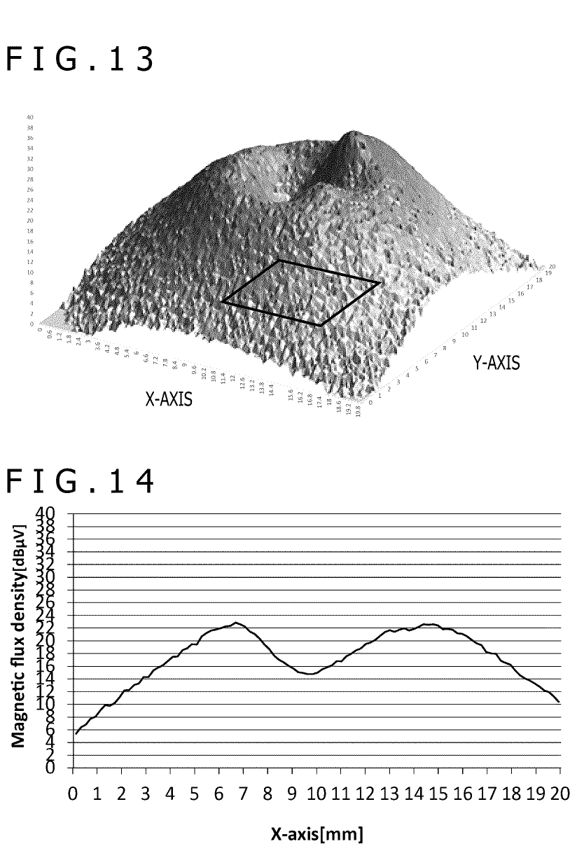

FIGS. 13 and 14 are graphs illustrating the measurement result of the near magnetic field with the coil component 110 of the first embodiment. FIG. 13 illustrates a three-dimensional graph of the measurement result in the measurement region R. FIG. 14 illustrates a graph of the measurement result at each point on a line that traverses the center of the coil component 110 in the X-direction.

In the three-dimensional graphs of FIGS. 11 and 13, the position of the coil component is indicated by a quadrangular frame on an XY-plane.

As illustrated in FIGS. 11 and 12, a strong magnetic field is generated directly above the coil component in the case of the coil component that does not include the shield. In contrast, as illustrated in FIGS. 13 and 14, in the case of the coil component 110 of the first embodiment, the intensity of the magnetic field is lowered directly above the coil component 110 relative to that of the surroundings. Thus, it turns out that the magnetic field is strongly suppressed by the shield 118.

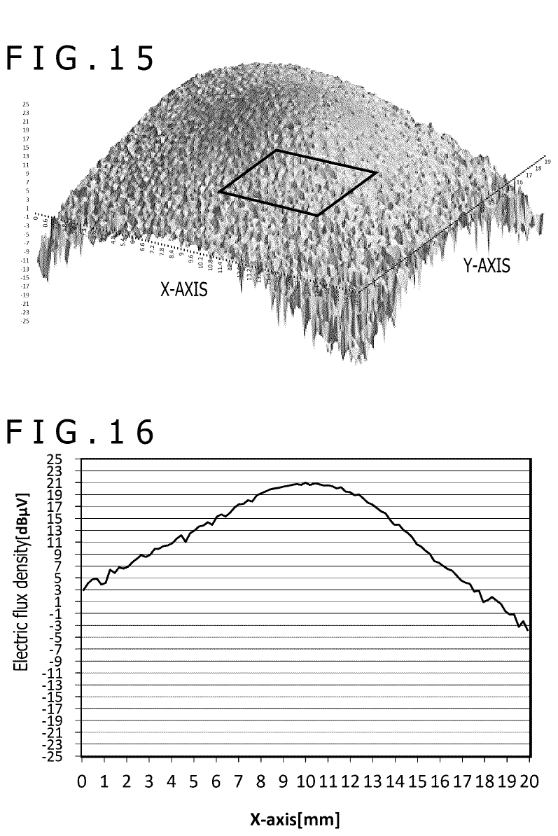

FIGS. 15 and 16 are graphs illustrating the measurement result of a near electric field with the coil component that does not include the shield. FIG. 15 illustrates a three-dimensional graph of the measurement result in the measurement region R. FIG. 16 illustrates a graph of the measurement result at each point on a line that traverses the center of the coil component in the X-direction.

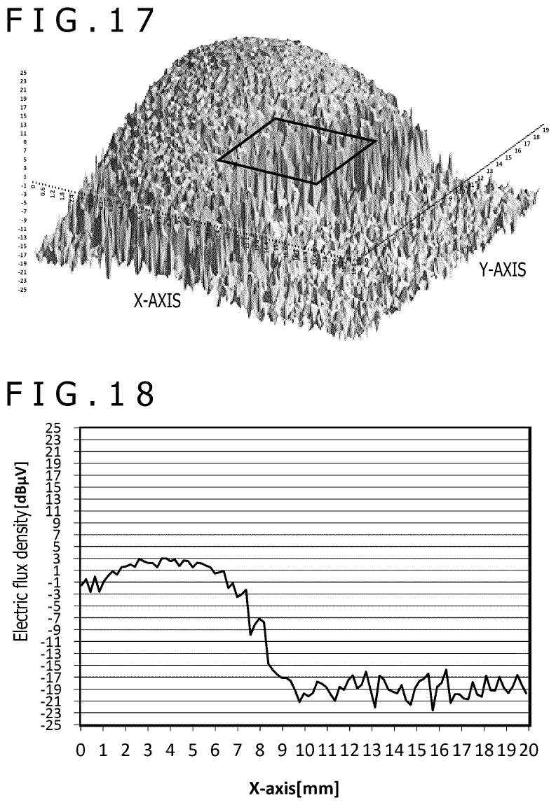

FIGS. 17 and 18 are graphs illustrating the measurement result of the near electric field with the coil component 110 of the first embodiment. FIG. 17 illustrates a three-dimensional graph of the measurement result in the measurement region R. FIG. 18 illustrates a graph of the measurement result at each point on a line that traverses the center of the coil component 110 in the X-direction.

In the three-dimensional graphs of FIGS. 15 and 17, the position of the coil component is indicated by a quadrangular frame on an XY-plane.

As illustrated in FIGS. 15 and 16, with the coil component that does not include the shield, a large measurement value is obtained directly above the coil component also in the case of the electric field similarly to the magnetic field. In contrast, as illustrated in FIGS. 17 and 18, it turns out that the electric field is suppressed and the suppression effect is significant particularly on the output side in the case of the coil component 110 of the first embodiment.

As above, the effect of noise suppression in the coil component 110 of the first embodiment has been confirmed also from the measurement of the near electromagnetic field.

The DC-DC converter is among representative examples with which the effect of noise suppression confirmed by the measurement of the far electromagnetic field and the near electromagnetic field is obtained. The output side of a circuit for which the coil component is used is designed to have low impedance in a wide band with a frequency band according to the switching frequency. In such a case, the effect of noise suppression is obtained because the output side of the coil component has the same function as that of the ground. For example, the switching frequency is at least 1 MHz and at most 10 MHz.

### Other Embodiments

Next, other embodiments will be described. In the following, description with focus on differences from the first embodiment will be made, and overlapping description is omitted.

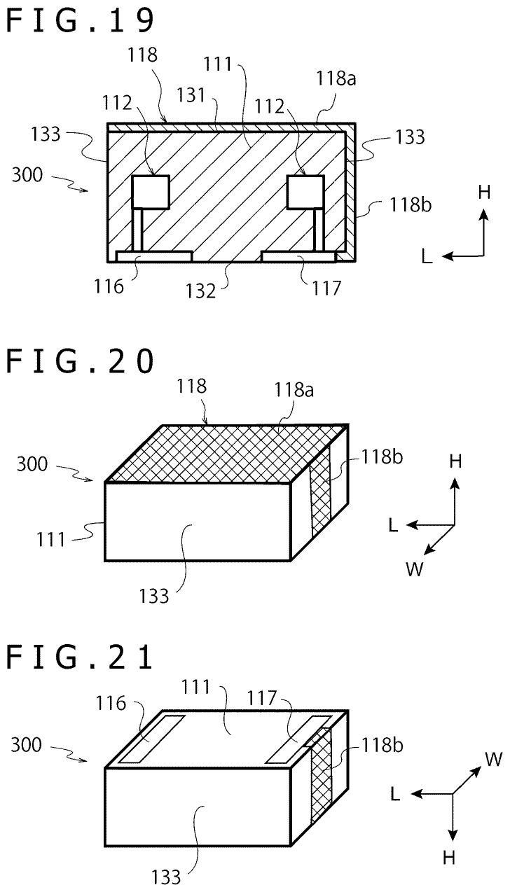

FIGS. 19 to 21 are diagrams illustrating a coil component of a second embodiment. A sectional view is illustrated in FIG. 19. A perspective view of the upper surface side is illustrated in FIG. 20. A perspective view of the lower surface side is illustrated in FIG. 21.

As with the coil component 110 of the first embodiment, a coil component 300 of the second embodiment includes the magnetic base 111, the internal conductor 112, the external electrode 116 on the input side, the external electrode 117 on the output side, and the shield 118. Further, the shield 118 has the upper surface portion 118a and the side-surface portion 118b. In the second embodiment, the side-surface portion 118b is at the minimum and is disposed on only one surface among the side surfaces 133 in order to couple the shield 118 with the external electrode 117 on the output side.

That is, in the coil component 300 of the second embodiment, the main part of the shield 118 extends on two outer surfaces out of the six outer surfaces (upper surface 131, lower surface 132, and four side surfaces 133) of the magnetic base 111. Magnetic flux that leaks from the magnetic base 111 to the outside is biased in a specific direction in many cases. In the coil component 300 of the second embodiment, for example, the leakage of magnetic flux is biased in the width direction w, and generation of the eddy current is suppressed by disposing the shield 118 with avoidance of the side surfaces 133 oriented in the width direction W.

Moreover, in the coil component 300 of the second embodiment, the areas of the external electrodes 116 and 117 are smaller than those in the coil component 110 of the first embodiment. Thus, suppression of the eddy current is allowed also for the external electrodes 116 and 117. Further, the external electrodes 116 and 117 do not reach the side surface 133 in the coil component 300 of the second embodiment. Thus, the external electrodes 116 and 117 do not affect the outer shape dimensions of the coil component 300 in the directions toward the side surface 133, and further size reduction of the coil component 300 is allowed.

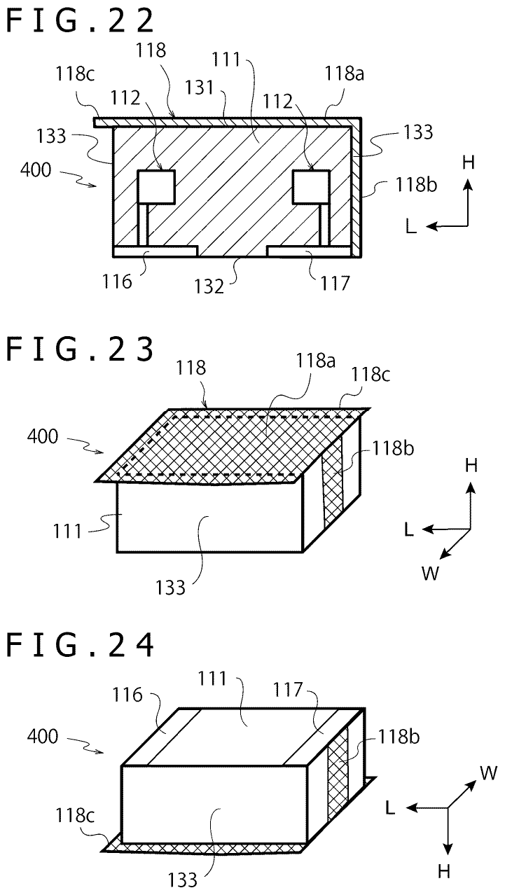

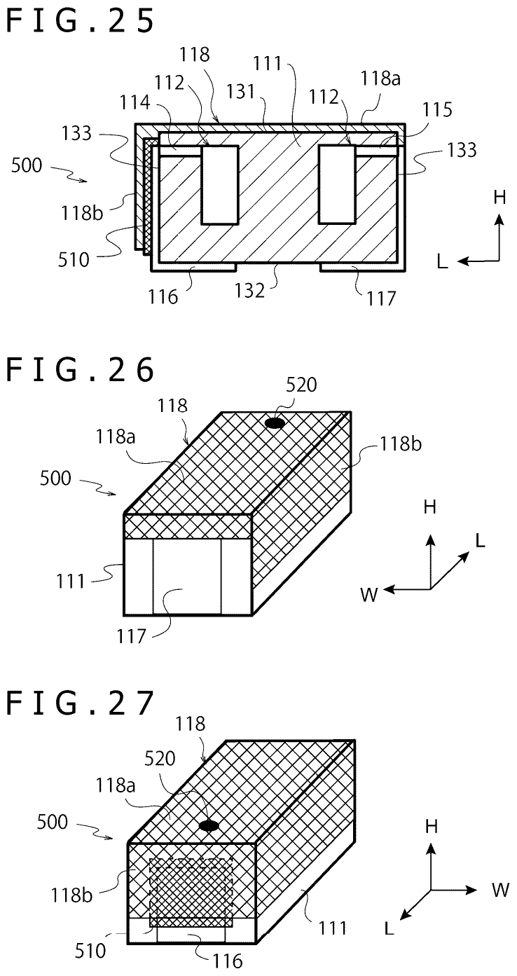

FIGS. 22 to 24 are diagrams illustrating a coil component of a third embodiment. A sectional view is illustrated in FIG. 22. A perspective view of the upper surface side is illustrated in FIG. 23. A perspective view of the lower surface side is illustrated in FIG. 24.

A coil component 400 of the third embodiment also includes the magnetic base 111, the internal conductor 112, the external electrode 116 on the input side, the external electrode 117 on the output side, and the shield 118.

In the third embodiment, the shield 118 has an overhang portion 118c in addition to the upper surface portion 118a and the side-surface portion 118b. The overhang portion 118c is extended from the upper surface portion 118a to stretch and hangover from the magnetic base 111. That is, as viewed in a −H-direction toward the upper surface 131, the overhang portion 118c of the shield 118 extends to the outside relative to the upper surface 131. Such an overhang portion 118c can reduce sneaking-around of an electromagnetic field (noise) from the side surface 133 on which the shield 118 is not disposed and can suppress increase in the eddy current generated in the shield 118.

Note that, although the overhang portion 118c overhangs from the upper surface 131 in three directions (+L-direction, +W-direction, and −W-direction) in the third embodiment, the overhang portion 118c may overhang from the upper surface 131 in only one direction, in two directions, or in four directions (+L-direction, −L-direction, +W-direction, and −W-direction). Moreover, when the overhang portion 118c overhangs in two directions, the two directions may be either two directions opposite to each other or two directions intersecting each other.

As the forming method of the shield 118 having the overhang portion 118c, for example, a method in which a metal plate is stuck to the upper surface 131 of the magnetic base 111, for example, is conceivable.

FIGS. 25 to 27 are diagrams illustrating a coil component of a fourth embodiment. A sectional view is illustrated in FIG. 25. A perspective view of the output side is illustrated in FIG. 26. A perspective view of the input side is illustrated in FIG. 27.

A coil component 500 of the fourth embodiment includes the magnetic base 111, the internal conductor 112, the external electrode 116 on the input side, the external electrode 117 on the output side, and the shield 118. In addition, the coil component 500 includes an insulating layer 510 and a mark 520.

In the coil component 500 of the fourth embodiment, what are generally called two-surface electrodes that range from the lower surface 132 to the side surface 133 are disposed as the external electrodes 116 and 117. Further, the lead-out portions 114 and 115 of the internal conductor 112 extend toward the side surface 133 of the magnetic base 111 and are connected to the external electrodes 116 and 117 on the side of the side surface 133.

In the case of the two-surface electrode, an electromagnetic field of noise is likely to be generated from the part that extends on the side surface 133 in the external electrode 116 on the input side. Thus, in the coil component 500 of the fourth embodiment, the side-surface portion 118b of the shield 118 reaches the input side of the coil component 500 and covers the external electrode 116 on the input side. Moreover, the insulating layer 510 is disposed between the external electrode 116 and the shield 118 in order to keep insulation between the external electrode 116 on the input side and the shield 118.

By such a shield 118, noise is suppressed even in the coil component 500 including the external electrodes 116 and 117 of two-surface electrodes.

The mark 520 is an indication portion that indicates the input side of the coil component 500. As the indication portion that indicates the input side of the coil component 500, a symbol or a character, for example, other than the mark 520 may be used. The input side of the coil component 500 is easily discriminated owing to the presence of the indication portion such as the mark 520. Therefore, mounting in the reverse direction, for example, is prevented.

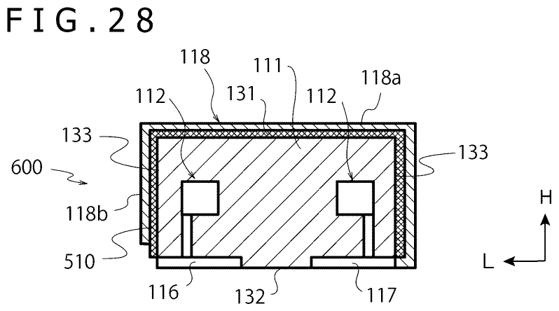

FIG. 28 is a sectional view illustrating a coil component of a fifth embodiment.

A coil component 600 of the fifth embodiment includes the magnetic base 111, the internal conductor 112, the external electrode 116 on the input side, the external electrode 117 on the output side, the shield 118, and the insulating layer 510.

In the coil component 600 of the fifth embodiment, the insulating layer 510 is disposed in a wide range inside the shield 118. The insulating layer 510 covers a plurality of surfaces (for example, upper surface 131 and two or more side surfaces 133) of the magnetic base 111 and may be disposed across the whole of the inside of the shield 118. A distance is made between the shield 118 and the magnetic base 111 by the insulating layer 510, and the eddy current is alleviated. The insulating layer 510 may double as an adhesive layer that fixes the shield 118 to the magnetic base 111.

The present disclosure contains subject matter related to that disclosed in Japanese Priority Patent Application JP 2023-138944 filed in the Japan Patent Office on Aug. 29, 2023, the entire content of which is hereby incorporated by reference.

What is claimed is:

1. A coil component comprising:
a magnetic base having magnetism;
a conductor disposed at part of the magnetic base;
an input-side electrode that is disposed on an outer surface of the magnetic base and is connected to one end of the conductor on an input side;
an output-side electrode that is disposed on an outer surface of the magnetic base and is connected to one end of the conductor on an output side; and
an electrically-conductive shield that is disposed on an outer surface of the magnetic base and is connected to the output-side electrode, a sum of area of the shield and area of the output-side electrode being larger than area of the input-side electrode.

2. The coil component according to claim 1, wherein
the magnetic base has a first surface on which the input-side electrode and the output-side electrode are disposed, a second surface oriented toward a side opposite to the first surface, and side surfaces that couple the first surface with the second surface, and
the shield has a second-surface portion disposed on the second surface and a side-surface portion disposed on the side surface.

3. The coil component according to claim 2, wherein,
in the shield, area of the second-surface portion is larger than total area of the side-surface portion.

4. The coil component according to claim 2, wherein,
in the shield, the second-surface portion covers 90% or higher of the second surface.

5. The coil component according to claim 4, wherein
the shield has an overhang portion located to range to an outside relative to the second surface as viewed toward the second surface.

6. The coil component according to claim 1, wherein,
in the shield, a thickness of the second-surface portion is equal to or smaller than a thickness of the output-side electrode.

7. The coil component according to claim 1, wherein
the shield contains a material with resistance higher than that of the output-side electrode.

8. The coil component according to claim 1, wherein
the shield is non-magnetic metal.

9. The coil component according to claim 2, wherein
the input-side electrode and the output-side electrode are separate from the side surfaces.

10. The coil component according to claim 1, further comprising:
an indication for identification of the input side and the output side of the conductor.
